(19) United States
(12) Patent Application Publication
(10) Pub. No.: US 2013/0105461 A1
(43) Pub. Date: May 2, 2013

(54) HUMAN FOOD AND BEVERAGE UTENSIL WATER SAVING HEATED DISHER WELL SYSTEM AND METHOD

(71) Applicants: Michael Huegerich, St. Louis, MO (US); Tom Hunot, Bridgeton, MO (US)

(72) Inventors: Michael Huegerich, St. Louis, MO (US); Tom Hunot, Bridgeton, MO (US)

(73) Assignee: WELLS BLOOMFIELD, LLC, St. Louis, MO (US)

(21) Appl. No.: 13/353,090

(22) Filed: Jan. 18, 2012

Related U.S. Application Data
(60) Provisional application No. 61/433,821, filed on Jan. 18, 2011.

(51) Int. Cl. H05B 1/02

(52) U.S. Cl. CPC H05B 1/0252
USPC 219/438

(57) ABSTRACT

Disclosed is a human food and beverage utensil heater well system for use with liquid for utensil heating, comprising a well with a drain outlet and removable plug fitting to close the outlet, with a heating system to heat the well. Electrical components are adapted to operate the heating system. The well can be configured to fit for mounting with a top housing adapted to rest upon a counter. The plug fitting can have a handle to remove the plug. A faucet can be operated to fill the well. The plug fitting can have a conduit therethrough to connect with an overflow tube so that liquid flows through the tube and plug fitting to be discharged through the outlet and through a drain tube. In an embodiment, a well and heater system can have a valve associated with the well outlet to open or close flow therethrough. The valves for the well outlet and faucet can be electrically controlled to open and close the valves, and can have timers to maintain the valves in the open positions to control the duration of the draining and filling operations. A support can fit within the well for supporting utensils.

### CROSS-REFERENCE TO RELATED APPLICATIONS

This Non-Provisional application claims priority to U.S. Provisional Application Ser. No. 61/433,821 filed Jan. 18, 2011, and which is incorporated herein by reference.

### STATEMENT REGARDING FEDERALLY SPONSORED RESEARCH

Not Applicable.

### BACKGROUND

The following detailed description illustrates the invention is a system and method relating to disher wells used with utensils for human food and beverages in connection with chef's counters, food and beverage serving counters, and beverage stations where food and beverage portion utensils are used. The invention provides savings of several gallons of water per day per disher well, such as about 189 gallons of water a day per disher well based on 13 hours of operation. The system and method reduces hot water costs by a substantial amount compared to standard hot water disher wells, and acts toward keeping the utensils in a sanitary condition.

The foregoing and other features, and advantages of the disclosure as well as embodiments thereof will become more apparent from the reading of the following description in connection with the accompanying drawings.

### DESCRIPTION OF THE DRAWINGS

FIG. 1 is a sectional view of the human food and beverage utensil and water saving heated disher well system;

FIG. 2 is a side elevation of the system of FIG. 1 with lower housing casing shown removed;

FIG. 3 is a bottom plan view of the system of FIG. 1 with lower housing casing shown removed;

FIG. 4 is a section view of the subassembly of the drain plug fitting with overflow tube and handle, taken along the line of 4-4 of FIG. 6;

FIG. 5 is a side elevation of the subassembly of the drain plug fitting, overflow tube and handle;

FIG. 6 is a bottom plan view of the subassembly shown in FIG. 5;

FIG. 7 is a sectional view of the drain plug fitting, taken along the line 7-7 of FIG. 9;

FIG. 8 is a side elevation of the drain plug fitting;

FIG. 9 is a top plan view of the drain plug fitting;

FIG. 9A is an exploded view of the system of FIG. 1;

FIG. 10 is a perspective view of disassembled components of the system;

FIG. 11 is a top perspective view of system components;

FIG. 12 is a top perspective view of a utensil shown positioned within the well cavity;

FIG. 13 is a top perspective view showing components of the system;

FIG. 14, is an isometric view looking from beneath an installed system with a counter;

FIG. 15 is an isolated side elevation of the casing of the lower housing of the system;

FIG. 16 is a plan view of the casing of the lower housing, in a flat sheet metal preformed configuration prior to shaping;

FIG. 17 is an isometric view of a modification of the system having a control system for the drain outlet, and a controlled system for the filler valve;

FIG. 18 is a side elevation of the system of FIG. 17;

FIG. 19 is another side elevation of the system of FIG. 17, from a view rotated 90° from that of FIG. 18;

FIG. 20 is an upper perspective view of parts of the system of FIG. 1;

FIG. 21 is a perspective view of components of the system of FIG. 1 with a utensil located within the well cavity, without the overflow tube and handle;

FIG. 22 is upper perspective view of the system of FIG. 1;

FIG. 23 is an exploded view of a modified system of FIG. 1, with the drain plug fitting without a handle and with the overflow tube extending into the top of the drain plug fitting;

FIG. 24 is a side elevation of the system of FIG. 1 with the lower housing casing shown installed;

FIG. 25 is a top plan view showing the system of FIG. 1; and

FIG. 26 is a side elevation view of the system of FIG. 1 with the lower housing casing shown installed, from a view rotated 90° from the view of FIG. 24.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

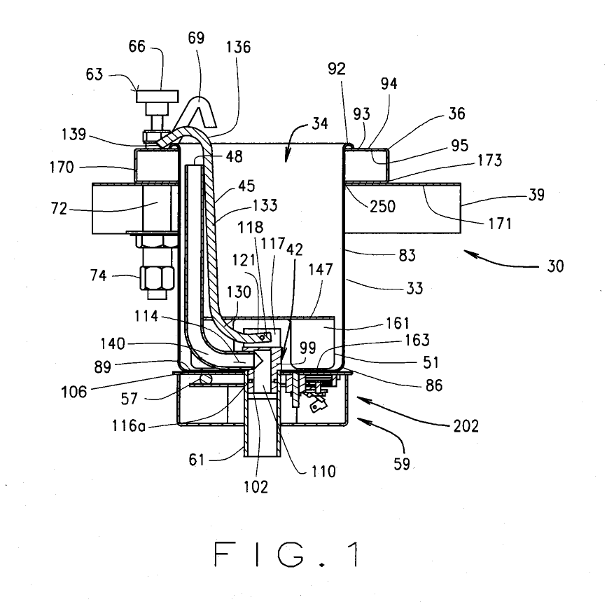

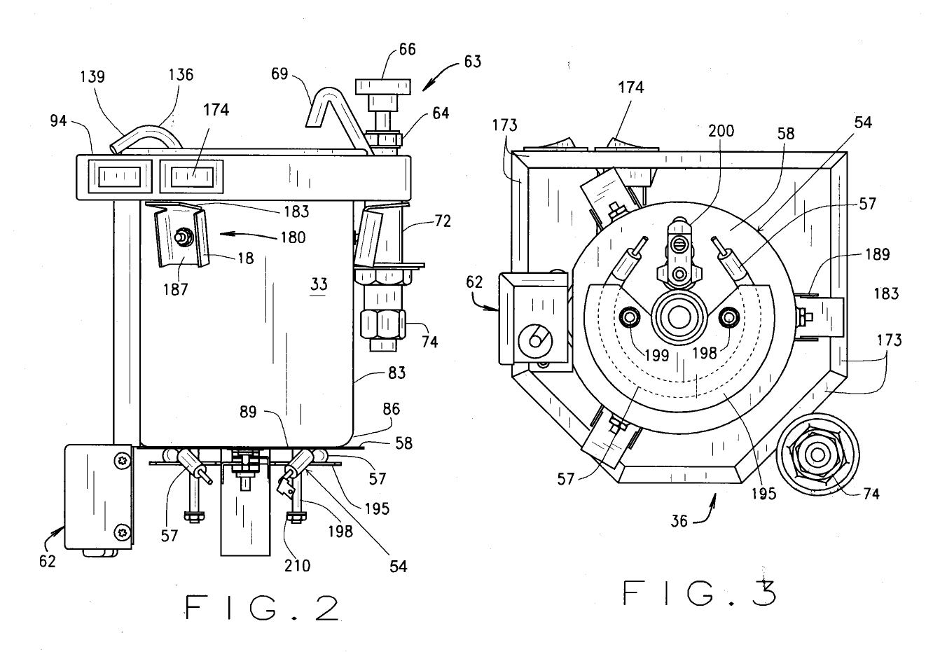

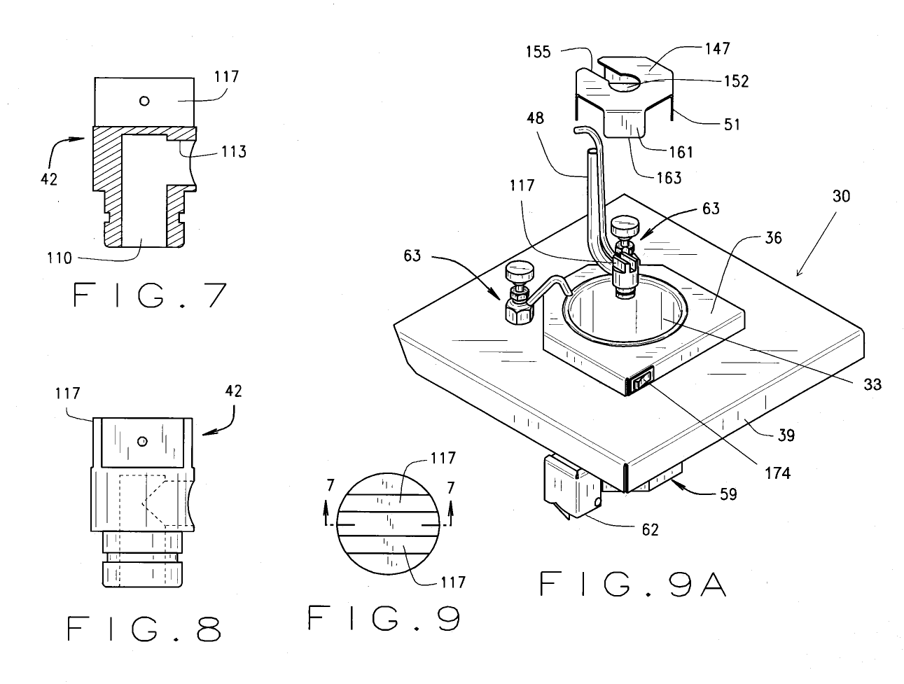

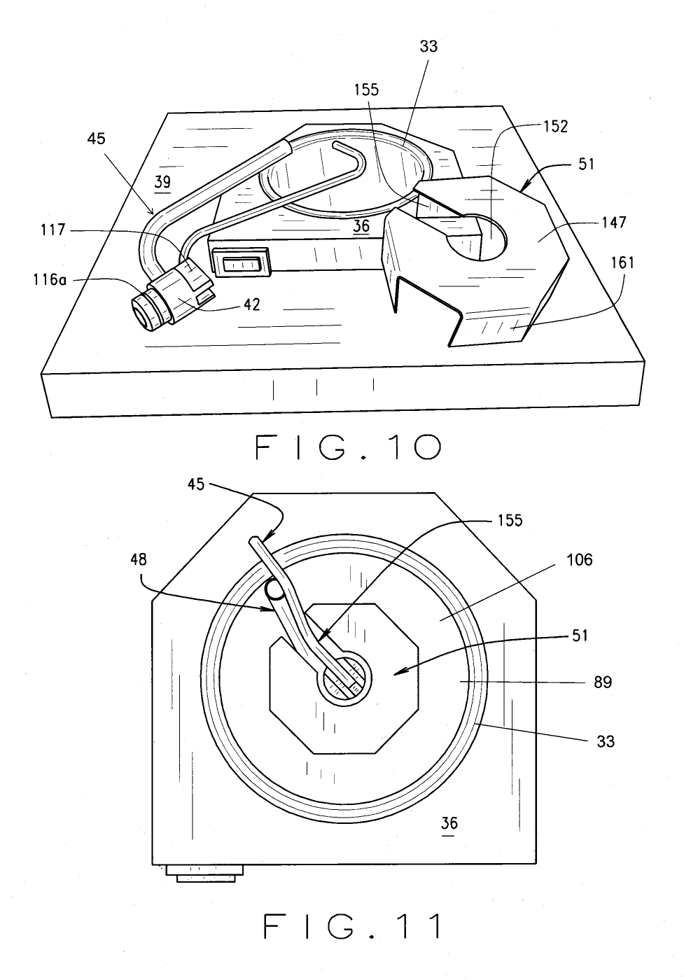

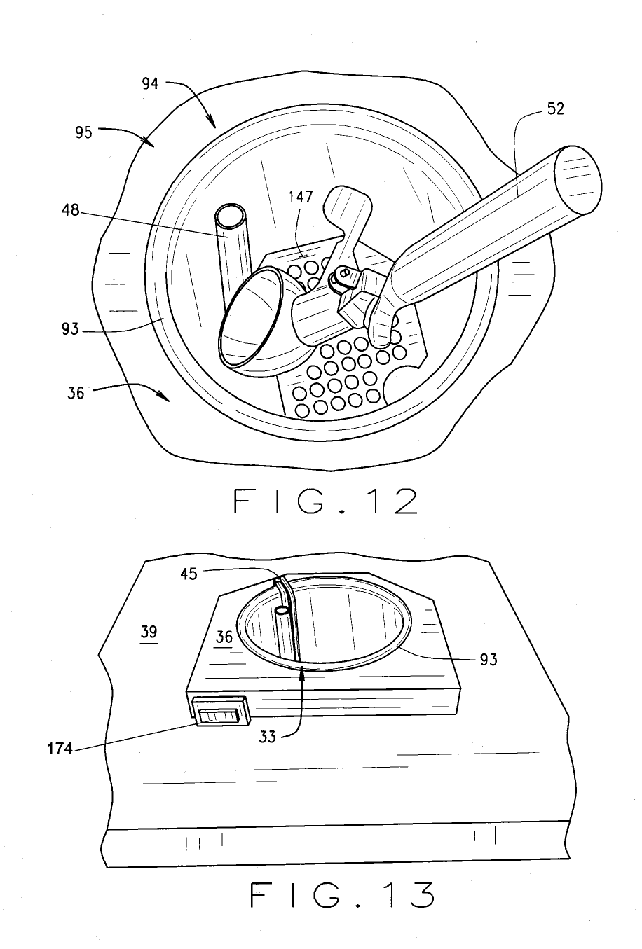

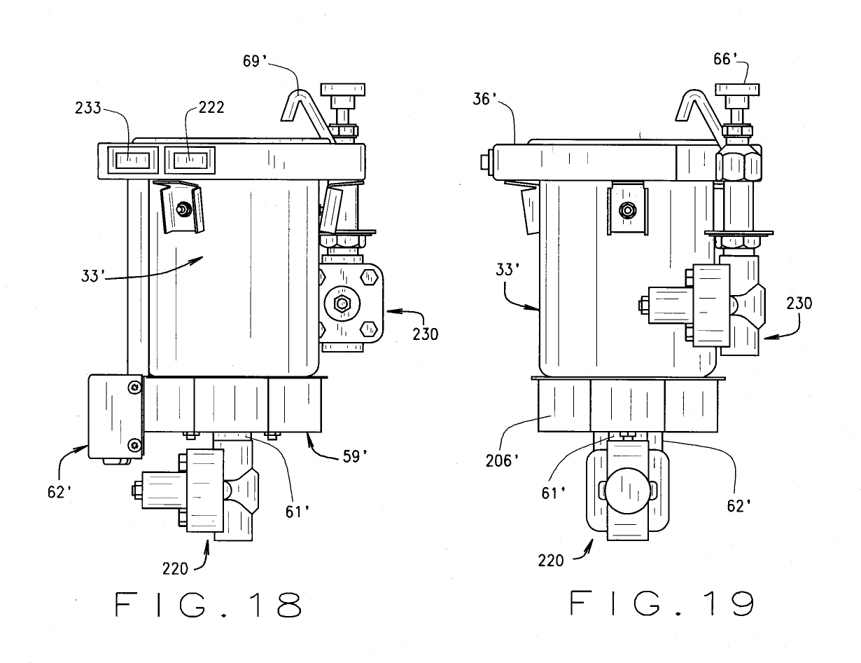

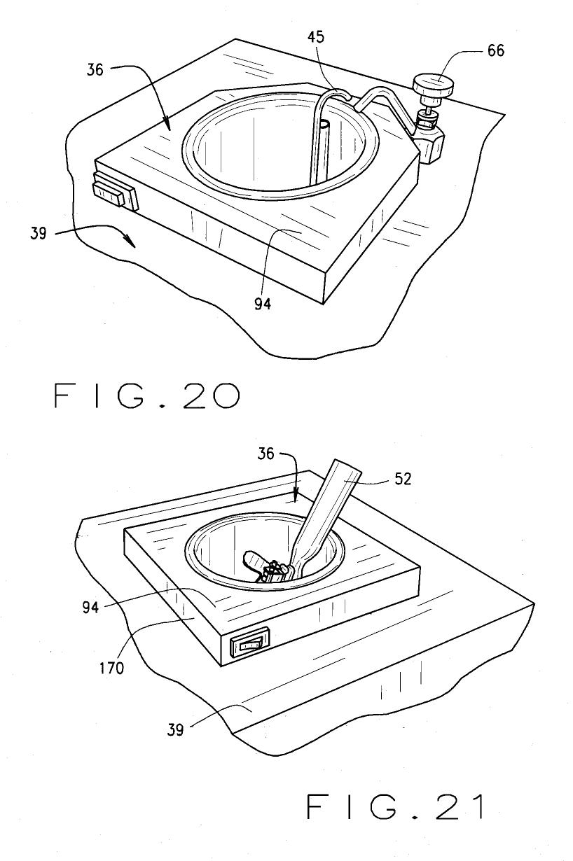

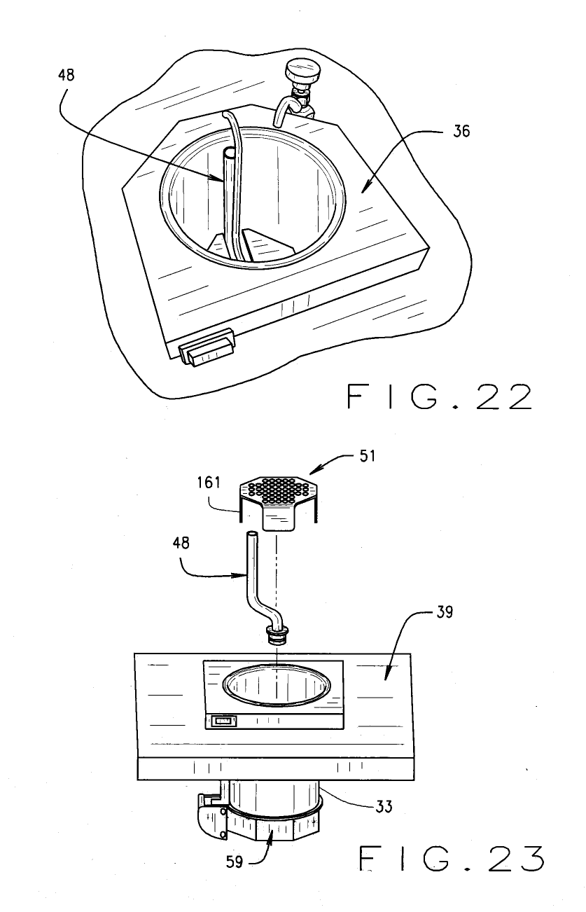

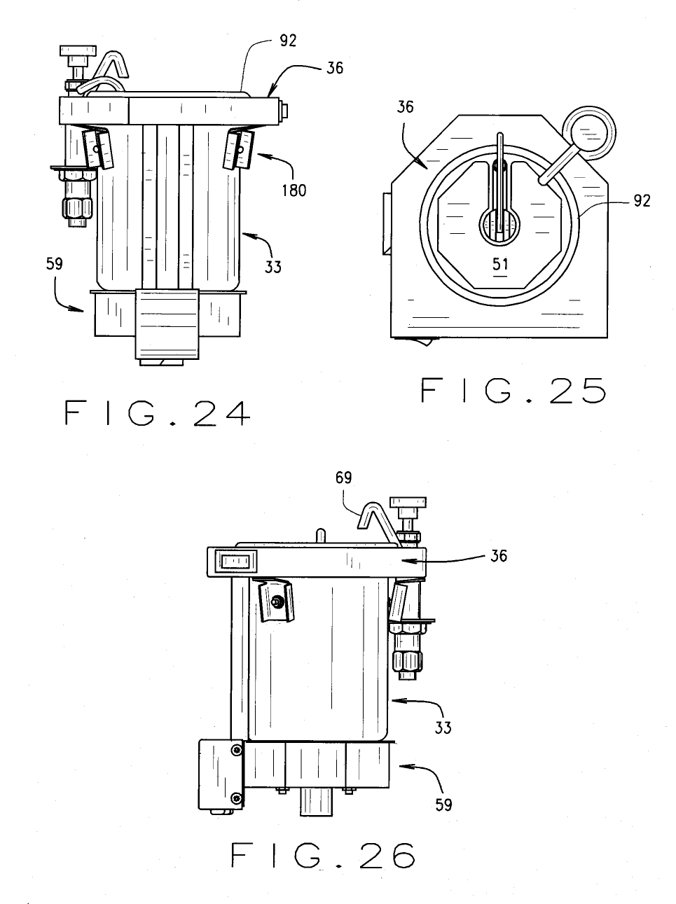

As shown in FIGS. 1-26, generally the system 30 comprises a well 33 having a cavity 34. Well 33 is mounted in relationship to a top housing 36. The housing 36 is shown resting above a counter 39. Toward its lower portion, the well 33 has an outlet opening which is associated with a drain plug fitting 42. The fitting 42 is associated with a drain handle 45. The fitting 42 also is in liquid flow association with an overflow tube 48 which has an upper end 49. The handle 45 can be hand operated to lift the drain fitting 42 out of well 33, and in conjunction therewith to remove the overflow tube 48.

The system 30 further comprises an insert or support 51, shown located toward the bottom of well 33. The support 51 acts to provide support for a food utensil such as a dipper, scoop, spoon, ladle or fork, for example, such as the scoop 52 shown in FIGS. 12 and 21. The system 30 further comprises a heating subsystem 54 which includes a heating element 57, heating plate 58 and electrical circuitry. element 57 is positioned relative to the well 33 so that heating subsystem 54 can be operated to heat the element 57. Element 57 heats heat transfer plate 58, which is preferably made of aluminum, and which transfer heat to the well 33 to thereby heat liquid within the well cavity 34. plate 58 also helps to mount element 57.

The system 30 additionally includes a lower housing 59 associated with the well 33. housing 59 can house the heating element 57, plate 58, as well as electrical wiring, a drain tube 61, and mounting components for element 57. The drain tube 61 can be positioned to be in fluid flow connection with the fitting 42. A control housing 62 can be mounted with housing 59, to act as a power inlet box to receive cords, wires and to house control systems for temperature and water flow that extend to electrical switches and to the heating element 57.

The system 30 further includes one or more faucet assemblies 63 that can discharge fluid into the well 33, one such faucet assembly 63 being shown in FIGS. 1-3, 17-19, 21-22. The faucet assembly 63 comprises a housing 64 with an operational component such as a handle or knob 66 illustrated, connected to a valve within the assembly 63 as known in the art, to block, or allow controlled liquid flow through a faucet nozzle 69. Faucet assembly 63 can comprise a flow tube or pipe 72 and a fitting 74 that can be connected to a water supply source. The faucet assembly 63 can be mounted in association with the counter 39. The faucet nozzle 69 is positioned so that water or other liquid can be discharged there from into the well cavity 34.

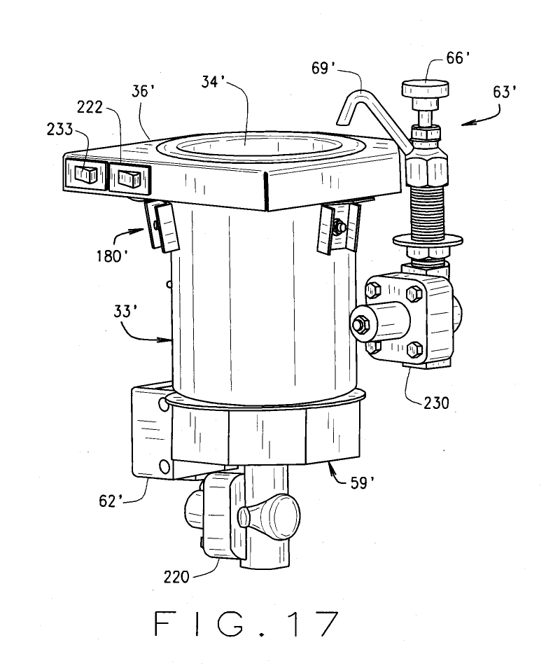

The system 30 can also comprise electrical circuitry and control valves such as solenoid valve fittings discussed hereafter and shown in FIGS. 17-19, to provide for draining the contents well cavity 34 for a predetermined amount of time and filling the well cavity 34 with water from the faucet assembly 63 for a predetermined amount of time.

The arrangement of the components of system 30 is such that the heating subassembly 54 can be operated to heat fluids, such as water, located within well cavity 34 to a temperature of at least 135° F., and will allow the system to be operated for extended periods of time, such as ten to thirty hours, at temperatures in the range of 135° F. to about 160° F. Food utensils can be placed in the well cavity 34 to rest upon support 51 to provide for sanitary location of the utensil while it is not being used.

More Detailed Description

Now, providing a more detailed description of system 30. The well 33 can be generally a container of a variety of shapes such as without limitation, a rectangular prism, triangular prism, octagonal prism, hexagonal prism, pentagonal prism, or cylindrical as shown in the drawings. Well 33 can have an outer wall such as the illustrated generally cylindrical vertical wall 83. Well wall 83 is shown to depend downwardly into a rounded area 86 which extends into a generally horizontal bottom wall 89. At the upper end of well 33, the wall 83 extends into an outwardly directed flange 92, shown curved with a concave underside and having an outer end 93 which can rest upon the upper surface 94 of the upper wall 95 of top housing 36. The upper end of the well 33 can be secured to the housing 36, such as by placing a bead of silicone adhesive within the concave portion of the upper well flange 92, and then extending the well 83 through the top of the opening through housing 36 with the underside of flange 92 facing the top surface 94 of housing upper wall 95 and held thereto so that the said adhesive within flange 92 bonds with top housing surface 94. This allows an integral bonding of the housing 36 with the well 33 so that those two members can be handled together during installation. Other means of bonding the well 33 with housing wall 95 can be used, such as by welding, brazing, or with threaded studs and nuts.

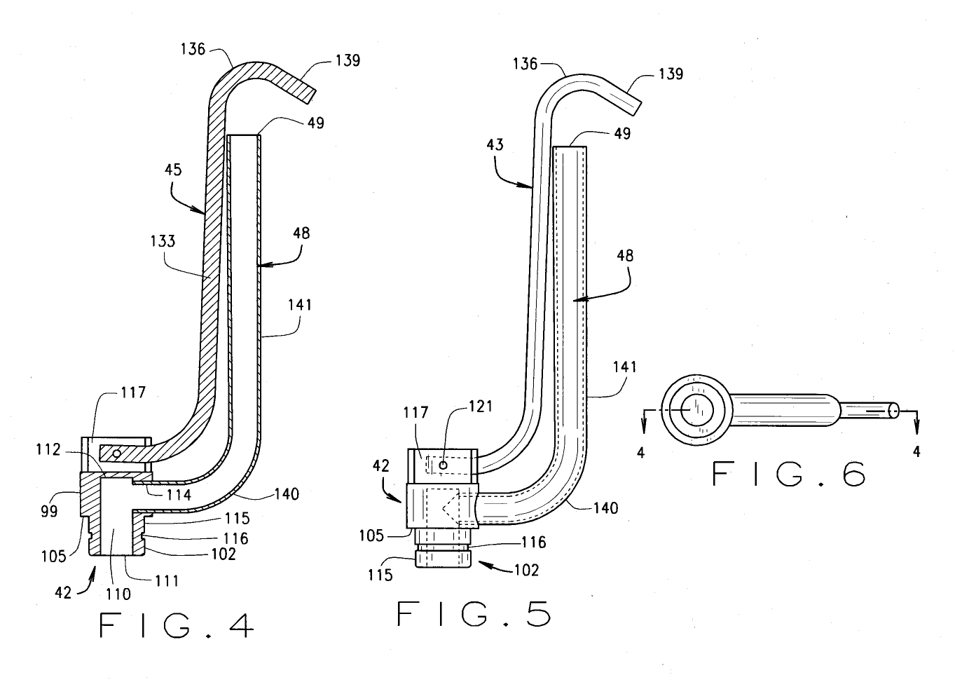

The drain fitting 42 is specifically shown to have a larger generally cylindrical upper section 99. As shown more clearly in FIGS. 4-9, section 99 depends downwardly into a lower generally cylindrical section 102, with a generally horizontal annular shoulder 105 located about the lower edge of bottom section 99. The fitting 42 is positioned relative to well 33 so that the annular shoulder 105 rests against the upper surface 106 of the well bottom wall 89 to be supported thereby. In that position, the fitting lower section 102 extends through a generally cylindrical drain opening in the well bottom wall 89. The pressure of shoulder 105 against surface 106 seals off liquid from flowing from the well cavity 34 to pass around the outside of fitting 42 and outside of drain tube 61.

Fitting 42 has a generally cylindrical cavity 110 that has its lower end opening 111 through the bottom of lower fitting section 102. The cavity 110 extends upwardly to within the upper fitting section 99. The upper end of cavity 110 is closed by the upper wall 112 of fitting section 99. A transverse bore 113 extends generally horizontally through a part of the wall of upper fitting section 99 to open into fitting cavity 110. the lower end section 114 of overflow tube 48 is telescopically received for a snug fit within transverse bore 113 and can be secured therein as by welding, so that fluid can flow through overflow tube 48 though transverse bore 113 and through cavity 110 thence through drain tube 61 to a general drainage pipe or tube (not shown). The lower fitting section 102 has an outer cylindrical surface 115 with an angular groove 116 that can receive a washer 116a.

The drain tube 61 is illustrated as generally cylindrical, but it can have other shapes such as rectangular prism, octagonal prism hexagonal prism or pentagonal prism. As shown, the outer cylindrical surface 115 of fitting lower section 102 is telescopically snugly received with drain tube 61 to allow fluid flow from the fitting cavity 110 into the tube 61. The tube 61 can be secured as by brazing to the lower well wall 89. The lower exterior of the drain tube 61 can be threaded if desired to accommodate a screw fitting with drainage hose fitting, or with, for example, a solenoid controlled valve fitting described below as to FIGS. 17-19.

A pair of mounting flanges 117 extends upwardly from the top of upper fitting section 99. The lower section 118 of drain handle 45 extends between the two flanges 117, and is spaced from the flanges 117. A pin 121 extends through the flanges 117 and through the handle lower section 118, so that the handle lower section 118 pivots freely between flanges 117 about pin 121.

The drain handle 45 can have a shape such as shown in the drawings whereby it extends from its lower section 118 connected to the flanges 117 to bend into curved section 130, and thence extends generally upward into a section 133. section 133 thence bends into a curved section 136 that extends into end segment 139. end segment 139 can rest against the upper surface 94 of top housing 36.

The overflow tube 48 extends from its lower end 114 into a curved segment 140 which extends into a generally vertical segment 141. The upper end 49 of tube 48 is located beneath the upper edge of the well 33, i.e., beneath the top surface of the well flange 92. Preferably the overflow tube is located about 0.5 inches to about 1.5 inches beneath the top edge of well 33, although different distances may be desired. Thus, from the illustration shown, when a level of water or other liquid within well cavity 34 rises above the upper end 49 of overflow tube 48, fluid within well cavity 34 will descend to flow through the overflow tube 48, through the drain fitting 42 and thence downwardly through drain tube 61 as described.

The utensil support 51 is shaped to have an upper platform section 147 upon which one or more utensils can rest. Support 51 has a structure that can depend downwardly from the platform section 147 to fit about the overflow tube 48 and drain handle 45, so that the lower end of the support 51 can rest generally upon or otherwise be supported by the well bottom wall 89. As illustrated. The upper support platform 147 has a generally octagonal configuration. platform 147 has an opening 152 sized to allow the drain fitting 42, as well as the lower end section of drain handle 45, to pass there-through when the handle 45 is lifted upward to remove the fitting 42. platform 147 also has an opening 155 that joins opening 152. Opening 155 is sized to allow overflow tube 48 and part of drain handle 45 to pass there-through. As shown, opening 155 extends through the outer edge of platform wall 147. Along each of four alternating sides of the octagonal support platform 147 depend generally vertical legs 161. Legs 161 are shown as flange shaped with their lower ends 163 resting upon the upper surface 106 of well lower wall 89.

The top housing 36 has a depending curtain wall 170 descending about the perimeter of upper housing top wall 95. At the lower edge of curtain wall 170 are inwardly extending flat feet sections 173. The bottoms of feet 173 can rest upon the upper surface of the counter 39 to supported housing 36 thereon. As shown in the drawings. The top housing 36 is hexagonal, with one part having a general trapezoid configuration facing the front of the counter 39 toward the operator, and the other unitary part having a generally rectangular configuration located near the back edge of the counter 39. The top housing upper wall 95 has a generally circular bore 182 which can be aligned with a generally cylindrical passageway extending through the surface of counter 39. Thus, the system 30 provides support for the well 33 by the well 33 being supported through its contact of annular flange 92 upon the top housing wall surface 94 and the support of the top housing 36 upon counter 39 as described. The housing 36 can have an electrical switch 174 mounted thereto. switch 174 can be a toggle switch having an “on” position whereby an electrical circuit is completed through the heating element 57 to heat fluid within the well cavity 34. Switch 174 also has an “off” position in which the circuit through heating element 57 is open so that the element 57 is not heated.

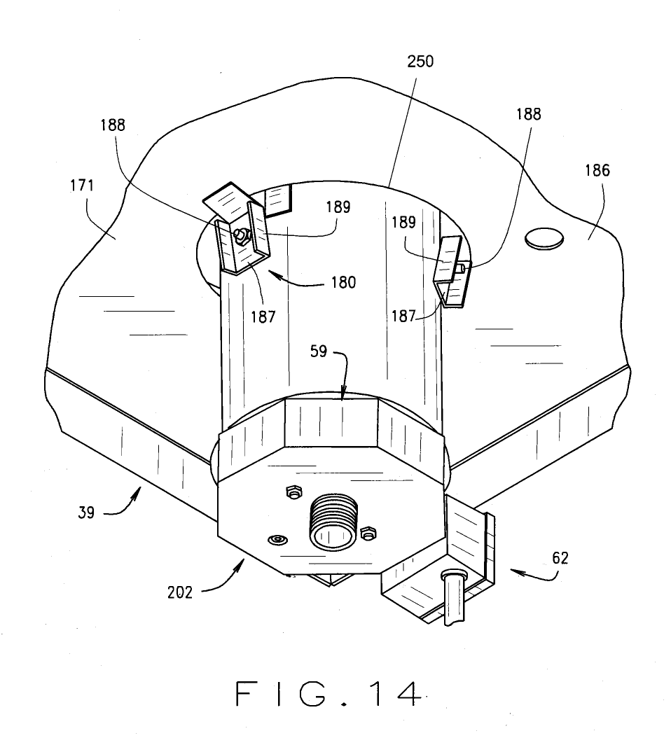

The well 33 can be secured to the counter such as by mounting brackets 180 as shown in FIG. 14. The mounting brackets have generally horizontal flanges 183 that can be secured to the underside of the horizontal wall 186 of the counter 39. The brackets 180 also have generally vertically extending flanges 187 which extend along the side of the outer surface of the well wall 83. A stud 188 is welded to the well wall 83, and stud 188 passes through an opening in each vertical flange 187, and thence stud 188 passes through a nut positioned against the outer surface of vertical flange 187 to thus secure well 33 to the counter 39. At both outer edges of vertical flange 87 are outwardly extending wing flanges 189.

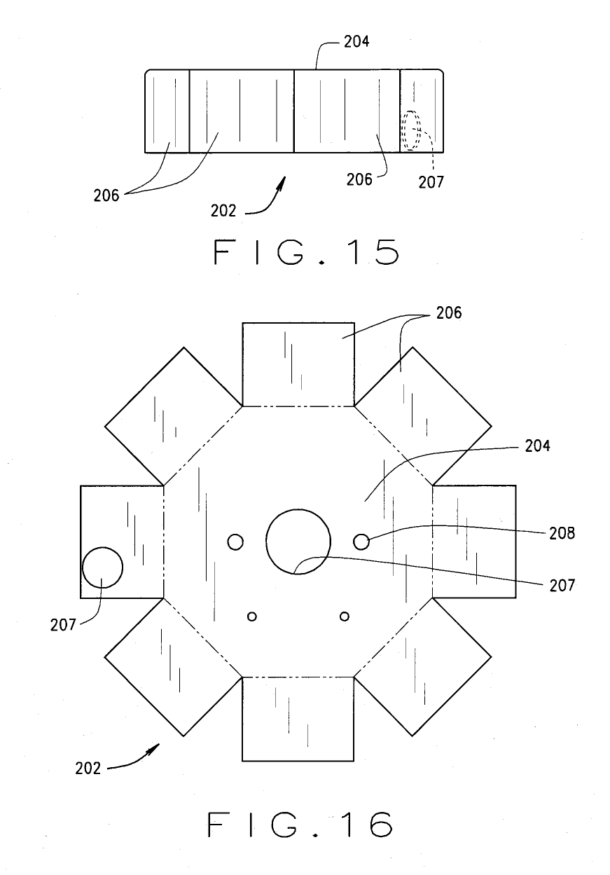

Housing 59 includes the top heat transfer plate 58 and a holding plate 195 that is mounted with threaded studs 198 attached to the bottom of the well 33 and secured with nuts 199 that abut the underside of plate 195 to support plate 195 a predetermined distance beneath heat plate 58. heating plate 58 is preferably of aluminum. The heating element 57 can have a generally arcuate shape. The heating element 57 rests upon the upper surface of holding plate 195 so that the top of the heating element 57 abuts the bottom surface of heat transfer plate 58 to be held there between to heat it and thereby heat the bottom well wall 89 and the contents of well cavity 34. The lower housing 59 further comprises a peripheral casing 202. Casing 202 is shown isolated in FIGS. 15-16. FIG. 16 shows the casing 202 layout in flat sheet metal preformed configuration prior to shaping it in the form of FIG. 16. The casing 202 in FIG. 15 as formed generally has an octagonal base wall 204 having eight side edges, from which extend at generally right angles a plurality of corresponding walls 206, yielding an octagonal shape for the casing 202. The casing base wall 204 has a generally centrally located circular opening 207 through which the drain tube 61 can extend. base 204 also has a pair of smaller circular openings 208 through which the studs 198 can pass and be secured by nuts 210 on the underside of base wall 204. One of the octagonal side walls 206 can have a circular opening 211 to receive electrical wiring from the control housing 62.

The heating subsystem 54 can also include a thermostat 213 in electrical connection with the electrical circuitry and heating element 57, and in sensing contact with the well bottom wall 89, to allow maintaining the temperature of the well cavity contents at a selected temperature.

The structure of the drain fitting 42 has been illustrated with the upper section 99 and lower section 102 preferably being unitary. Alternatively they can be integral with one another. The flanges 117 are preferably unitary with fitting section 99, or alternatively can be integral with each other. Drain tube 75 is preferably integral with the upper wall of the bottom housing 59. The heating element 57 preferably has an arcuate configuration as shown, but could be of different shapes, such as serpentine, U-shaped or spiral. If desired, the heating plate 58 can have a conforming recess on its underside shape to receive the heating element 57. Further, element 57 and heating plate 58 can be integral and one piece. Element and holding plate 195 can be of one piece, and be recessed.

Various other modifications of this design as described and shown could be made. For example, the support 51, drain handle 45, overflow tube 48 and fitting 42 can be shaped and arranged so that both the handle 45 and overflow tube 48 extend generally vertically from the fitting 42. the overflow tube lower end could extend through the top of fitting section 99 to connect the tube flow to the cavity 110. In such case, the mounting of the handle 45 to a flange or flanges secured to the fitting section 42 can be offset. With such an arrangement the drain tube and the handle could also be curved toward their bottoms to come in at different angles or directions to connect with the drain fitting 42. In such an example, the support 51 can have centrally located opening and need not have an opening extend to the outer edge of the support platform 147. The platform 147 can also be perforated with a plurality of holes such as illustrated in FIG. 12.

The faucet control is illustrated with a rotatable knob, but could be by other known means such as by lever handle or push button. The location of the faucet assembly 63 can vary, with FIG. 9A showing two possible locations.

In installation and operation, the opening 250 in counter platform wall 171 is sized and shaped to allow accommodate passage there through of the well 33, the lower housing 59 and the control housing 62. For example, the counter hole can be generally circular and about 6″ in diameter to accommodate a well having a diameter from about 4.8″ to about 5.0″. An assembly 253 of the top housing 36, well 33, lower housing 59 and control housing 62 can be positioned so that the central vertical axis of well 33 is tilted at an angle relative to the counter platform 171 to pass lower housing 59, control housing 62 and the lower part of well 33 through the counter hole 250. Once lower housing 59, control housing 62 and the lower part of well 33 clear through hole 250, the axis of well 33 is tilted to a generally vertical position to slide the well wall 83 through the platform opening 250 until the top housing feet 173 rest upon the top surface of counter platform 171. Electrical connections are made to control housing 62 to provide electrical power to assembly 30.

The lower housing 59 housing heating element 57 is positioned relative to the well 33 to heat liquid in the well cavity 37 to a temperature of at least 135 F.° as described.

The drain fitting 42 with drain handle 45, and overflow tube 48 are placed so fitting 42 is located as shown in FIG. 1. The faucet assembly 63 is installed to be connected to a supply pipe so that water can flow there from into the well cavity 34 up to the level of the overflow tube upper end 49. When it is desired to discharge the contents of well cavity 34, the drain handle 45 can be grasped to remove the drain fitting 42 to allow liquid within the well cavity 34 to flow through the drain tube 61.

The utensil support 51 is placed within the cavity 34 of well 33 so that the support 51 is supported by the structure of well 33, and so that the support 51 is placed within the cavity 34 of the well 33 so that the platform 147 is positioned to support a food utensil, with the structure of support 51 fitting about the drain fitting 42, the overflow tube 140 and the drain handle 45, such as previously described.

As shown in the embodiment of FIGS. 17-19, the system 30′ can also be provided with a valve fitting 220 having a flow path there through controlled by a solenoid. fitting 220 is mounted toward the bottom of, and in fluid flow connection with, drain tube 61′, such as the lower exterior of drain tube 61′ being threaded to be received with a threaded inlet bore of the fluid flow path of the valve fitting 220. Alternatively, the interior of drain tube 61′ can be threaded at its lower end to receive the externally threaded male end of a solenoid valve fitting. With this embodiment the drain plug fitting 42, handle 45 and overflow tube 48 are not present. The solenoid controlled valve of fitting 220 can be actuated through a momentary switch 222 to open the valve to allow fluid to pass through fitting 220 to thereby drain the well cavity 34′. A timer and electrical and electronic circuitry can be provided and can be located in part in the control housing 62′ and connected in conjunction with the switch 222 to hold the solenoid valve 220 open for a predetermined amount of time for well drainage. Alternatively, the momentary switch 222 and circuitry can be such as to have the valve of fitting 220 to remain open as long as the button of switch 222 is pressed.

An automatic filling operation can also be performed through electrical and electronic circuitry connected with a solenoid controlled valve fitting 230. Fitting 230 has a flow path there through controlled by a solenoid. Fitting 230 is mounted toward the bottom of, and in fluid flow connection with, faucet assembly 63′. With the faucet knob 66′ rotated to place the valve of faucet assembly 63′ in an “open” position, the solenoid controlled valve of fitting 230 can be actuated through a momentary switch 233 to open the valve of fitting 230 to allow fluid to pass through fitting 230 to thereby flow through the faucet assembly 63′, thence discharged through faucet nozzle 69′ in to well cavity 34′. A timer can be provided in the circuitry, and located such as in the control housing 62′ and connected in conjunction with the switch 233 to maintain the solenoid valve of fitting 230 open for a predetermined amount of time for pouring water through nozzle 69′ in to well cavity 34′. If the solenoid controlled fitting 230 is used, the faucet assembly 63′ can, if desired, be provided sans the manually controlled valve such as controlled by knob 66′, so that the only control of flow through the faucet assembly 63′ is by the solenoid controlled fitting 230.

The solenoid controlled valve fittings 220 and 230 can be those as are commercially available. One example of such fitting is STC Valve® model number 2P200-3/4 sold by Sizto Tech Corporation having an address of 892 Commercial Street, Palo Alto, Calif. 94303, USA. Another example of such fitting is Beta Valve brand solenoid valve model number 6115BC sold by Beta Valve System s Ltd., Park House Business Centre, Desborough Park Road, High Wycombe, Bucks HP12 3DJ, United Kingdom.

The solenoid valve fitting 220 and its electrical circuitry as described can be operated in tandem with the solenoid controlled valve fitting 230 to drain and fill the well cavity 34′ in sequence. To drain and fill the well cavity 34′, the operator pushes the momentary switch 222 to open the solenoid controlled valve of fitting 220 for a predetermined amount of time to drain the well cavity 34′ through drain tube 61. After that, the momentary switch 222 is released to close the valve of drain fitting 220. Following that, the switch 233 can be activated to open the valve in fitting 230 so that water flows though faucet nozzle 69 to fill well cavity 34′ as described.

The electrical circuitry and its timing controls can be provided so that rather than using two switches 222 and 233, a single switch is used with electrical circuitry to automatically open and shut the values of solenoid valve fittings 220 and 230 to drain, then fill, well cavity 34′. The said switch, which can be located in the same position as switch 222 can be activated with its associated circuitry to open the solenoid controlled valve of fitting 230 to drain the well cavity 34′ for a preselected period of time. After passage of that preselected period of time, the electrical circuitry with timer acts with the solenoid of fitting 220 to close the valve of fitting 220. Within a short period of time thereafter, such as preferably about 1 to about 8 seconds, the circuitry timing acts to open the valve of faucet solenoid fitting 230 to allow water to flow through fitting 230 through nozzle 69′ in to well cavity 34′ to a preselected level, such as just beneath the overflow tube top 49. After that, the circuitry acts with the solenoid valve of fitting 230 to close the valve of fitting 230 to stop flow of water through fitting 230 and through nozzle 69.

Rather than having a single switch such as described, the electrical circuitry can be provided to begin the draining operation within a preselected amount of time following the filling of the well cavity 34′. The filling operation would then automatically follow the draining operation such as described above. Alternatively the commencement of the well draining operation can be programmed to be triggered to begin based on the level of food waste accumulation in the well cavity 34′. When that predetermined amount of waste accumulation is detected, such as by an electronic control that measures the resistivity of the water in the well cavity 34′, the circuitry commences the cycle by activating the solenoid of drain fitting 220 to open the valve of fitting 220 to drain the well cavity 34′.

Changes can be made in the above constructions without departing from the scope of the disclosure, it is intended that all matter contained in the above description or shown in the accompanying drawings shall be interpreted as illustrative and not in a limiting sense.

What is claimed is:

1. A human food and beverage utensil heater well system for use with liquid for utensil heating, comprising:
a well having a bottom and structure which together with the bottom form a cavity, the well having an upper opening and a drainage outlet opening having an edge, the well cavity being sized and shaped to be capable of receiving a utensil;
a removable drain plug fitting shaped to be capable of being associated with the well drainage outlet to close the outlet opening about the edge of the outlet opening; and
a heating subsystem including a heating element, the heating subsystem capable of being associated with the well to transfer heat from the heating element to the well.

2. The system of claim 1 wherein the system further comprises the heating subsystem having electrical circuitry connected to the heating element, and a switch electrically connected to the circuitry, the switch having a first position adapted to complete an electrical circuit through the heating element and a second position adapted to open the electrical circuit.

3. The system of claim 2 wherein the system further comprises a top housing having an opening sized for receiving and mounting of the well, and wherein the switch is mounted in association with the top housing.

4. The system of claim 1 wherein the system further comprises the drain plug fitting having a flow path extending through the plug fitting and through the well drainage outlet, and an overflow tube having a proximal end and a distal end with a conduit extending there through from the distal end to the proximal end, the distal overflow tube end being capable of being positioned beneath the upper opening of the well, and the overflow tube proximal end being shaped to be capable of being connected to the fitting so that a flow passage is formed from the distal end of the overflow tube through the plug fitting and through the drainage outlet.

5. The system of claim 1 wherein the system can be operated by a human hand, the system further comprising a handle member having a distal end shaped for gripping by a human hand, the handle member being connected with the plug fitting to be capable of pulling the plug fitting from the drain outlet when the plug fitting is fitted within the drain outlet.

6. The system of claim 1 wherein the system further comprises a support shaped to fit upon the well bottom to fit within the well cavity, the support having a platform section and structure depending from the platform shaped to be capable of resting on the well bottom to support the platform, the platform section having an opening sized and shaped to fit about the handle.

7. The system of claim 4 wherein the system further comprises a drain tube having a flow path there through, the drain tube shaped to fit in relationship to the drain plug fitting so that the drain plug fitting flow path connects to the drain tube flow path.

8. The system of claim 5 wherein the plug fitting has an upper end and the handle has a proximal end that is pivotally mounted to the upper end of the fitting.

9. The system of claim 3 further comprising the well having a vertically extending wall and the well having at its upper end an outwardly extending flange, and the top housing having an upper surface with the top housing opening extending through said top housing upper surface, the opening being sized and the well and its flange being sized to be capable of allowing passage of the well wall through the top housing opening so that the well flange is capable of contacting the top housing upper surface to resist movement of the well flange through the top housing opening.

10. In the environment of a counter which counter has an opening, the system of claim 9, wherein the top housing has a wall depending from its upper surface, with the bottom of the said wall being supported upon the counter, with the well wall being capable of being aligned to extend through the counter opening, and the well wall having connectors capable of connecting the well wall to the counter.

11. In the system of claim 3, further comprising the system comprising a faucet with a valve capable of being positioned to allow flow of water from the faucet when the faucet is connected to a water source, the faucet being positioned relative to the well to allow water to be capable of flowing from the faucet into the well upper opening

12. A human food and beverage utensil heater well system for use with liquid for utensil heating, comprising:
a well comprising a bottom and a vertically extending wall which together form a cavity, the well having an upper opening and a drainage outlet opening having an edge, the well cavity being sized and shaped to be capable of receiving a utensil;
a removable drain plug fitting shaped to be capable of being associated with the well drainage outlet to close the outlet opening about the edge of the outlet opening; and
a heating subsystem including a heating element, the heating subsystem capable of being associated with the well to transfer heat from the heating element to the well,
the heating subsystem having electrical circuitry connected to the heating element, and a switch electrically connected to the circuitry, the switch having a first position adapted to complete an electrical circuit through the heating element and a second position adapted to open the electrical circuit;
a top housing having an opening sized for receiving and mounting of the well with the top housing, the switch being mounted in association with the top housing; and
a handle member having a distal end shaped for gripping by a human hand, the handle member being connected with the plug fitting to be capable of pulling the plug fitting from the drain outlet when the plug fitting is fitted within the drain outlet.

13. A human food and beverage utensil heater well system for use with liquid for utensil heating, comprising:
a well comprising a bottom and a vertically extending wall which together form a cavity, the well having an upper opening and a drainage outlet opening having an edge, the well cavity being sized and shaped to be capable of receiving a utensil;
a removable drain plug fitting shaped to be capable of being associated with the well drainage outlet to close the outlet opening about the edge of the outlet opening, the drain plug fitting having a flow path extending through the plug fitting and through the well drainage outlet, and an overflow tube having a proximal end and a distal end with a conduit extending there through from the distal end to the proximal end, the overflow tube proximal end being shaped to be capable of being connected to the fitting so that a flow passage is formed from the distal end of the overflow tube through the plug fitting and through the drainage outlet;
a heating subsystem including a heating element, the heating subsystem capable of being associated with the well to transfer heat from the heating element to the well;
the heating subsystem having electrical circuitry connected to the heating element, and a switch electrically connected to the circuitry, the switch having a first position adapted to complete an electrical circuit through the heating element and a second position adapted to open the electrical circuit;
a top housing having an opening sized for receiving and mounting of the well with the top housing, the switch being mounted in association with the top housing;
a handle member having a distal end shaped for gripping by a human hand, the handle member being connected with the plug fitting to be capable of pulling the plug fitting from the drain outlet when the plug fitting is fitted within the drain outlet; and
a support shaped to fit upon the well bottom to fit within the well cavity, the support having a platform section and structure depending from the platform shaped to be capable of resting on the well bottom to support the platform.

14. A method for using a heater well system for heating human food and beverage utensils, comprising the steps of: providing a well having a bottom and structure which together with the bottom form a cavity, the well having an upper opening and a drainage outlet opening having an edge, the well cavity being sized and shaped to be capable of receiving a utensil;
providing a removable drain plug fitting shaped to be capable of being associated with the well drainage outlet to close the outlet opening about the edge of the outlet opening; and
providing a heating subsystem including a heating element, the heating subsystem capable of being associated with the well to transfer heat from the heating element to the well;
providing liquid into the well cavity;
operating the heating subsystem to heat the liquid in the well cavity to a temperature of at least 140° F.; and
placing a utensil in the well cavity so that the utensil is within the cavity during a time period that the liquid is heated.

15. The method of claim 14, further comprising the step of providing the heating subsystem to have electrical circuitry connected to the heating element, and a switch electrically connected to the circuitry, the switch having a first position adapted to complete an electrical circuit through the heating element and a second position adapted to open the electrical circuit, and further comprising the step of operating the switch to close the electrical circuit.

16. The method of claim 15 further comprising providing a handle member having a distal end, the handle member having a proximal section connected with the plug fitting; placing the plug fitting within the drain outlet; and grasping the distal part of the handle member to pull it so that the handle member pulls the plug fitting from the drain outlet.

17. The method of claim 16 further comprising: the steps of providing the drain plug fitting with a flow path extending through the plug fitting and through the well drainage outlet, providing an overflow tube having a proximal end and a distal end with a conduit extending there through from the distal end to the proximal end, positioning the distal overflow tube end beneath the upper opening of the well, providing that the overflow tube proximal end be shaped to be connected to the fitting so that a flow passage is formed from the distal end of the overflow tube through the plug fitting and through the drainage outlet; and the flowing of liquid from the distal end of the overflow tube through the drainage outlet.

18. The method of claim 17 further comprising the steps of providing a support shaped to fit upon the well bottom to fit within the well cavity, the support having a platform section and structure depending from the platform shaped to be capable of resting on the well bottom to support the platform; placing the support within the well cavity so that the depending support structure rests on the well bottom and supports the platform above the well bottom; and placing a utensil in the well cavity to rest upon the platform.

19. The method of claim 18 further comprising the steps of providing a support shaped to fit upon the well bottom to fit within the well cavity, the support having a platform section and structure depending from the platform shaped to be capable of resting on the well bottom to support the platform, the platform section having an opening sized and shaped to fit about the handle; placing the support so that its depending structure rests on the well bottom; and moving the support so that the handle passes into the platform opening to position the platform about the handle.

20. The method of claim 19 further comprising the steps of providing a drain tube having a flow path there through, and engaging the drain tube with the drain plug fitting so that the drain plug fitting flow path connects to the drain tube flow path.

21. A human food and beverage utensil heater well system for use with liquid for utensil heating, comprising:
a well having a bottom and structure which together with the bottom form a cavity, the well having an upper opening and an outlet opening for permitting liquid drainage there through, the well cavity being sized and shaped to be capable of receiving a utensil;
a heating subsystem including a heating element, the heating subsystem capable of being associated with the well to transfer heat from the heating element to the well; and
a drain valve connected to receive liquid flow from the well drainage outlet, the drain valve having a closed position that does not allow liquid flow through the drain valve, and an open position to allow liquid to flow from the drain outlet through the drain valve, wherein the drain valve comprises an electrical connection to a drain control device that is capable of opening or closing the drain valve.

22. The system of claim 21 wherein the drain control device is a solenoid.

23. The system of claim 21 further comprising a drain switch electrically connected to the drain control device, the drain switch having a first position adapted to send a signal to an electrical circuit to position the drain valve in the open position.

24. The system of claim 23 wherein the electric circuit comprises a timing circuit electrically connected to the drain switch, the timing circuit adapted to maintain the drain valve in the open position for a predetermined amount of time in response to the signal.

25. The system of claim 21 further comprising a drain switch electrically connected to the drain control device, the switch having a first position adapted to signal an electrical circuit to position the drain valve in the closed position and a second position adapted signal the electrical circuit to position the drain valve in the open position.

26. The system of claim 21 further comprising a fill valve connected to a liquid source to provide liquid flow to the well, the fill valve having an open position that allows liquid flow through the fill valve and a closed position that does not allow liquid to flow through the fill valve.

27. The system of claim 26, wherein the fill valve comprises an electrical connection to a fill control device that is capable of opening or closing the fill valve.

28. The system of claim 27 wherein the fill control device is a solenoid.

29. The system of claim 27 further comprising a fill switch electrically connected to the fill control device, the fill switch having a first position adapted to send a signal to an electrical circuit to position the fill valve in the open position.

30. The system of claim 29 wherein the electrical circuit comprises a timing circuit electrically connected to the fill switch, the timing circuit adapted to maintain the fill valve in the open position for a predetermined amount of time in response to the signal.

31. The system of claim 27 further comprising a fill switch electrically connected to the fill control device, the fill switch having a first position adapted to signal an electrical circuit to position the fill valve in the closed position and a second position adapted signal the electrical circuit to position the fill valve in the open position.

32. A human food and beverage utensil heater well system for use with liquid for utensil heating, comprising:
a well having a bottom and structure which together with the bottom form a cavity, the well having an upper opening and an outlet opening for permitting liquid drainage there through, the well cavity being sized and shaped to be capable of receiving a utensil;
a heating subsystem including a heating element, the heating subsystem capable of being associated with the well to transfer heat from the heating element to the well; and
a fill valve connected to a liquid source to provide liquid flow to the well, the fill valve having an open position that allows liquid flow through the fill valve and a closed position that does not allow liquid to flow through the fill valve and wherein the fill valve comprises an electrical connection to a fill control device that is capable of opening or closing the fill valve.

33. The system of claim 32 wherein the fill control device is a solenoid.

34. The system of claim 32 further comprising a fill switch electrically connected to the fill control device, the fill switch having a first position adapted to send a signal to an electrical circuit to position the fill valve in the open position.

35. The system of claim 34 wherein the electrical circuit comprises a timing circuit electrically connected to the fill switch, the timing circuit adapted to maintain the fill valve in the open position for a predetermined amount of time in response to the signal.

36. The system of claim 32 further comprising a fill switch electrically connected to the fill control device, the fill switch having a first position adapted to signal an electrical circuit to position the fill valve in the closed position and a second position adapted signal the electrical circuit to position the fill valve in the open position.

37. A human food and beverage utensil heater well system for use with liquid for utensil heating, comprising:
a well having a bottom and structure which together with the bottom form a cavity, the well having an upper opening and an outlet opening for permitting liquid drainage there through, the well cavity being sized and shaped to be capable of receiving a utensil;
a heating subsystem including a heating element, the heating subsystem capable of being associated with the well to transfer heat from the heating element to the well;
a drain valve connected to receive liquid flow from the well drainage outlet, the drain valve having a closed position that does not allow liquid flow through the drain valve, and an open position to allow liquid to flow from the drain outlet through the drain valve wherein the drain valve comprises an electrical connection to a drain control device that is capable of opening or closing the drain valve; and
a fill valve connected to a liquid source to provide liquid flow to the well, the fill valve having an open position that allows liquid flow through the fill valve and a closed position that does not allow liquid to flow through the fill valve and wherein the fill valve comprises an electrical connection to a fill control device that is capable of opening or closing the fill valve.

38. The system of claim 37 wherein the drain control device and the fill control device each comprise solenoids.

39. The system of claim 37 further comprising a switch electrically connected to the drain control device and the fill control device, the switch having a first position adapted to send a signal to an electrical circuit which is adapted to operate the fill and drain control valves to position the drain valve in the open position for predetermined period of time, close the drain valve, open the fill valve for a predetermined period of time, and close the fill valve.

40. The system of claim 39 wherein the electrical circuit instructs the fill valve to open before closing the drain valve to rinse the well.
